(19) United States
(12) Patent Application Publication
(10) Pub. No.: US 2012/0003932 A1
(43) Pub. Date: Jan. 5, 2012

(54) METHOD AND SYSTEM FOR REDUCING POWER CONSUMPTION IN BLUETOOTH PROXIMITY IMPLEMENTATIONS

(76) Inventor: Victor Zhodzishsky, Potomac, MD (US)

(21) Appl. No.: 12/857,457

(22) Filed: Aug. 16, 2010

Related U.S. Application Data
(60) Provisional application No. 61/360,854, filed on Jul. 1, 2010.

(51) Int. Cl. H04W 52/02

(52) U.S. Cl. 455/41.2

(57) ABSTRACT

A Bluetooth host controller located in a Bluetooth proximity host comprising a Bluetooth host device may be configured to automatically generate a set of notifications or triggers based on the relative proximity to other Bluetooth devices. The Bluetooth host device stays in a lower power mode until one of the Bluetooth triggers is received.

### CROSS-REFERENCE TO RELATED APPLICATIONS/INCORPORATION BY REFERENCE

This patent application makes reference to, claims priority to and claims benefit from U.S. Provisional Patent Application Ser. No. 61/360,854 (Attorney Docket No. 23008US01) filed on Jul. 1, 2010.

The above stated application is hereby incorporated herein by reference in its entirety.

### FIELD OF THE INVENTION

Certain embodiments of the invention relate to communication systems. More specifically, certain embodiments of the invention relate to a method and system for reducing power consumption in Bluetooth proximity implementations.

### BACKGROUND OF THE INVENTION

Bluetooth is a Personal Area Network (PAN) standard for wireless communications between Bluetooth enabled communication devices. This technology eliminates cables and wires between devices, facilitates both data and voice communication, and enables ad-hoc networks between various Bluetooth devices. Integration of the technology is rapidly expanding in the industry, as it is convenient, easy-to-use, and has the bandwidth to meet the rapidly expanding demands of today's mobile and personal communication applications. Bluetooth-enabled applications may comprise cellular phones, cordless phones, access points, desktop PCs, notebook PCs, printers, digital camcorders and cameras, a broad variety of consumer equipment such like game controllers, speakers, headset, set-top boxes and MP3 players, and automotive and industrial applications. Different Bluetooth services may require different type of connection. For example, a Bluetooth enabled phone and a Bluetooth headset may remain connected in order to receive a call indication, for example, even if they are not in the same room. For example, a Bluetooth enabled PC may create a temporary connection to a Bluetooth phone to send a file and disconnect right after a transmission is completed.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A method and/or system for reducing power consumption in Bluetooth proximity implementations, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a diagram illustrating an exemplary communication system that is operable to reduce power consumption in a Bluetooth proximity solution, in accordance with an embodiment of the invention.

FIG. 2 is a block diagram illustrating exemplary steps that may be performed by a Bluetooth proximity host to reduce power consumption of the Bluetooth host device while keeping the Bluetooth host controller powered up, in accordance with an embodiment of the invention.

FIG. 3 is a block diagram illustrating exemplary steps that may be performed by a Bluetooth proximity host to configure the Bluetooth host controller to notify the Bluetooth host device if an associated Bluetooth proximity device comes into the proximity range of the Bluetooth proximity host, in accordance with an embodiment of the invention.

FIG. 4 is a block diagram illustrating exemplary steps that may be performed by a Bluetooth proximity host to configure the Bluetooth host controller to notify the Bluetooth host device if an associated Bluetooth proximity device gets out of the proximity range of the Bluetooth proximity host, in accordance with an embodiment of the invention.

### DETAILED DESCRIPTION OF THE INVENTION

Certain embodiments of the invention may be found in a method and system for reducing power consumption in Bluetooth proximity implementations. In various embodiments of the invention, a Bluetooth host controller that is located in a Bluetooth proximity host communication device (a Bluetooth proximity host) comprising a Bluetooth host device is operable to automatically generate Bluetooth proximity triggers without being requested by the Bluetooth host device. For example, a Bluetooth proximity presence trigger is generated in instances when a Bluetooth proximity device enters a corresponding presence range of the Bluetooth proximity host. For example, a Bluetooth proximity away trigger is generated in instances when a Bluetooth proximity device goes out of a corresponding away range of the Bluetooth proximity host. One or more of the Bluetooth proximity triggers, generated by the Bluetooth host controller, may allow Bluetooth host device to stay in the low power mode until trigger occurs.

The Bluetooth host controller may be operable to measure received signal strength (RSSI) of signals communicated by the Bluetooth proximity device. The RSSI measurements or the RSSI measurements plus transmit power level of the Bluetooth proximity device may be compared with a presence threshold values corresponding to the presence range of the Bluetooth proximity host. For example, in instances where the RSSI measurements for the Bluetooth proximity device becomes greater than the presence threshold value, the Bluetooth host controller may generate a Bluetooth proximity presence trigger indicating the presence of the Bluetooth proximity device within the presence range. The Bluetooth host controller may transmit the generated Bluetooth proximity presence trigger utilizing a HCI event to the Bluetooth host device to trigger the Bluetooth host device to start execution of one or more applications such as auto logon for the Bluetooth proximity device. In instances where the RSSI measurements for the Bluetooth proximity device become less than an away threshold value corresponding to the away range of the Bluetooth proximity host, the Bluetooth host controller may generate a Bluetooth proximity away trigger. The Bluetooth host controller may transmit the generated Bluetooth proximity away trigger in a HCI event to the Bluetooth host device to trigger the Bluetooth host device to execute one or more applications for the Bluetooth proximity device, for example logoff or computer lock. In this regard, the Bluetooth host device does not need to run any application to monitor distance to the proximity device and may stay in the low power mode until trigger occurs.

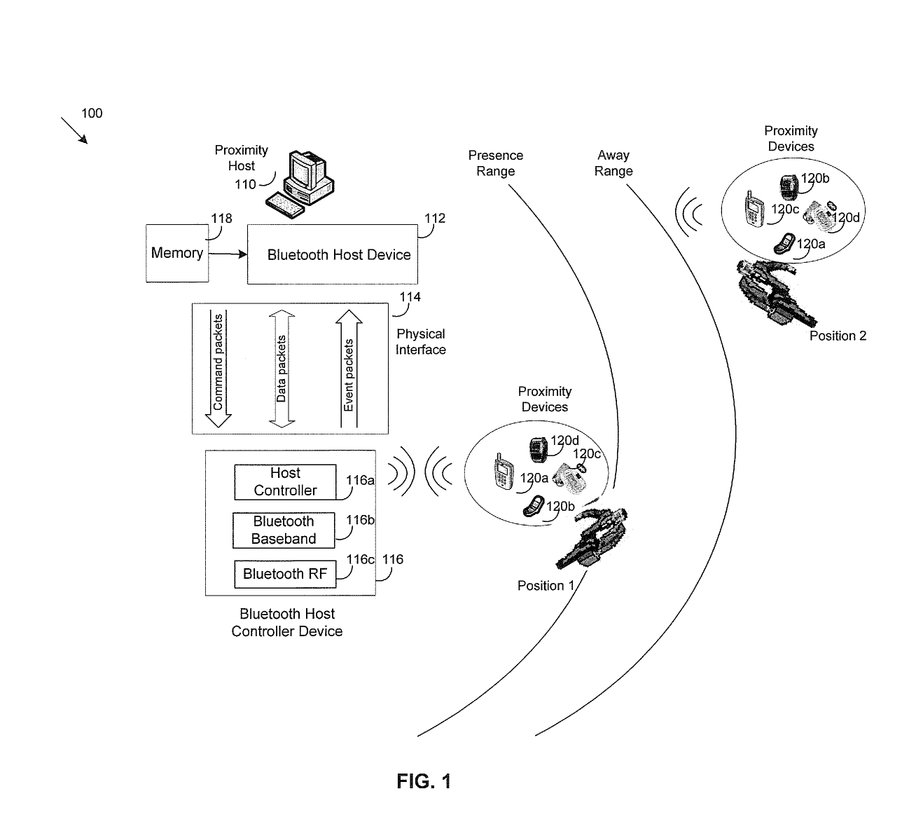

FIG. 1 is a diagram illustrating an exemplary communication system that is operable to reduce power consumption in a Bluetooth proximity solution, in accordance with an embodiment of the invention. Referring to FIG. 1, there is shown a proximity system 100. The proximity system 100 comprises a Bluetooth proximity host 110 and a plurality of Bluetooth proximity devices, of which Bluetooth proximity devices 120a-120d at position 1 and position 2 are illustrated. The Bluetooth proximity host 110 may comprise a Bluetooth host device 112, a physical interface 114, a Bluetooth host controller device 116 and a memory 118. The Bluetooth host controller device 116 comprises a Bluetooth host controller 116a, a Bluetooth baseband 116b and a Bluetooth RF 116c.

The Bluetooth proximity host 110 may comprise suitable logic, circuitry, interfaces and/or code that are operable to perform actions or run applications, with the software running on the Bluetooth host device 112 of the Bluetooth proximity host 110. In order to perform actions related to a Bluetooth proximity device, the Bluetooth proximity host 110 may configure the Bluetooth host controller device 116 to measure RSSI and/or transmit power level of the Bluetooth proximity device so as to track the relative distance between the Bluetooth proximity host 110 and the Bluetooth proximity device. In an exemplary embodiment of the invention, the Bluetooth host controller device 116 may be operable to perform relative distance (proximity) measurements for the Bluetooth proximity device without affecting existing functionality. For example, whenever possible, the Bluetooth proximity host 110 may utilize an existing connection with the Bluetooth proximity device for proximity measurements without interrupting existing functionality. In instances where a connection needs to be established with the Bluetooth proximity device for proximity measurements, the Bluetooth proximity host 110 may be configured to create an asynchronous connection-oriented link (ACL) connection to the Bluetooth proximity device without breaking existing functionality on the Bluetooth proximity host 110 as well as the Bluetooth proximity device.

In various exemplary embodiments of the invention, the Bluetooth proximity host 110 may start or stop performing actions or running applications related to an associated Bluetooth proximity device at a time when the associated Bluetooth proximity device comes into a presence range or goes out of an away range of the Bluetooth proximity host 110. For example, in instances where the Bluetooth proximity host 110 knows that the associated Bluetooth proximity device such as the Bluetooth proximity device 120a at the position 1 is coming into the presence range, the Bluetooth proximity host 110 may start executing applications such as auto logon with the software running on the Bluetooth host device 112 for the Bluetooth proximity device 120a. In instances where the associated Bluetooth proximity device such as the Bluetooth proximity device 120a at the position 2 goes outside of the away range, the Bluetooth proximity host 110 may start running applications related to the away condition of the Bluetooth proximity device 120a on the Bluetooth host device 112.

The Bluetooth host device 112 may comprise suitable logic, circuitry, interfaces and/or code that are operable to manipulate and control operations of the Bluetooth host controller device 116 via a set of Bluetooth protocols to support Bluetooth applications such as, for example, Bluetooth hands-free and Bluetooth proximity. The Bluetooth host device 112 may run, as host software, higher layers of the Bluetooth protocol stack, for example, HCI-Driver, L2CAP, SDP, and/or RFCOMM to handle or maintain communication with other Bluetooth devices using the Bluetooth host controller device 116 through the physical interface 114.

The Bluetooth host device 112 may operate either in a normal power mode or in a low power mode. In the normal power mode, circuits and/or signals on the Bluetooth host device 112 may be fully turned on to process traffic between the Bluetooth host device 112 and the Bluetooth host controller device 116, and/or to perform actions such as auto login for Bluetooth proximity devices served within the presence range or operating proximity. The traffic between the Bluetooth host device 112 and the Bluetooth host controller device 116 may comprise Bluetooth packets such as, for example, command packets, event packets and data packets. The data packets may comprise asynchronous (ACL) and/or Synchronous (SCO) packets. In a low power mode, at least a portion of the circuits and/or signals on the Bluetooth host device 112 may be turned off. Traffic processing on the Bluetooth host device 112 may also be turned off when needed. The Bluetooth host device 112 may maintain and control the power usage of the Bluetooth host device 112 based on Bluetooth proximity information of an associated Bluetooth proximity device such as the Bluetooth proximity device 120a at the position 2. Bluetooth proximity information of the Bluetooth proximity device 130a indicates how far the Bluetooth proximity device 120a is from the Bluetooth host device 112 with regard to various ranges such as, for example, the presence range and/or the away range.

In an exemplary embodiment of the invention, the Bluetooth host device 112 may be operable to create and send a Host Controller Interface (HCI) command to the Bluetooth host controller 116a for configuring Bluetooth proximity triggers in the Bluetooth host controller 116a. In this regard, the Bluetooth host device 112 may inform, through the HCI command, the Bluetooth host controller 116a to send a Bluetooth proximity presence trigger or a Bluetooth proximity away trigger to the Bluetooth host device 112 at a time when a Bluetooth proximity device comes into a corresponding presence range or goes out of a corresponding away range of the Bluetooth proximity host 110. More specifically, the Bluetooth host device 112 does not need to periodically check with the Bluetooth host controller 116a about how far an associated Bluetooth proximity is. Instead, the Bluetooth host device 112 may configure the Bluetooth host controller 116a to automatically send a Bluetooth proximity presence trigger or a Bluetooth proximity away trigger to the Bluetooth host device 112 only when an associated Bluetooth proximity device comes into a corresponding presence range or goes out of a corresponding away range of the Bluetooth proximity host 110.

In an exemplary embodiment of the invention, the Bluetooth host device 112 may be operable to receive, without sending a request to the Bluetooth host controller 116a for Bluetooth proximity information such as how far an associated Bluetooth proximity device is, a HCI event, comprising a Bluetooth proximity presence trigger, from the Bluetooth host controller 116a in the Bluetooth host controller device 116 at a time when the associated Bluetooth proximity device such as the Bluetooth proximity device 120b at the position 1 comes into a corresponding presence range. The received Bluetooth proximity presence trigger may indicate the Bluetooth host device 112 that the Bluetooth proximity device 120b at the position 1 is coming into the presence range. In this regard, the Bluetooth host device 112 may be operable to start running the host software to perform actions such as, for example, auto login and/or other similar application related to a presence condition of the Bluetooth proximity device 120b.

In an exemplary embodiment of the invention, the Bluetooth host device 112 may be operable to receive, without sending a query to the Bluetooth host controller 116a for Bluetooth proximity information such as how far an associated Bluetooth proximity device is, a HCI event, comprising a Bluetooth proximity away trigger, from the Bluetooth host controller 116a in the Bluetooth host controller device 116 at a time when the associated Bluetooth proximity device such as the Bluetooth proximity device 120a at the position 2 goes out of an away range. The received Bluetooth proximity away trigger may indicate the Bluetooth host device 112 that the Bluetooth proximity device 120a at the position 2 has moved outside of the away range. In this regard, upon receiving the Bluetooth proximity away trigger from the Bluetooth host controller 116a, the Bluetooth host device 112 may be operable to, for example, automatically log off. The host device 112 may also stop or suspend running some applications and may stay in the low power mode until a Bluetooth proximity presence trigger occurs.

The physical interface 114 may comprise suitable logic, circuitry, interfaces and/or code that are operable to provide a transport connection between the Bluetooth host device 112 and the Bluetooth host controller device 116. The physical interface 114 may utilize USB, SDIO and/or UART connections, for example.

The Bluetooth host controller device 116 may comprise suitable logic, circuitry, interfaces and/or code that are operable to establish and manage Bluetooth connections with an associated Bluetooth proximity device through the Bluetooth host controller 116a, the Bluetooth baseband 116b and the Bluetooth RF 116c.

The Bluetooth host controller 116a may comprise suitable logic, circuitry, interfaces and/or code that are operable to handle commands, events and data packets defined in the Bluetooth specification. For example, the Bluetooth host controller 116a may be operable to process HCI commands and/or data packets from the Bluetooth host device 112, and communicate HCI events and/or data packets to the Bluetooth host device 112.

In an exemplary embodiment of the invention, the Bluetooth host controller 116a may receive HCI commands comprising instructions from the Bluetooth host device 112 to configure the Bluetooth host controller 116a. In this regard, according to the instructions in the received HCI commands, the Bluetooth host controller 116a may be operable to automatically generate a Bluetooth proximity presence trigger or a Bluetooth proximity away trigger at a time when an associated Bluetooth proximity device comes into the presence range or goes out of the away range of the Bluetooth proximity host 110.

In an exemplary embodiment of the invention, the Bluetooth host controller 116a may be configured to automatically send a Bluetooth presence trigger or a Bluetooth proximity away trigger to the Bluetooth host device 112 at a time when an associated Bluetooth proximity device comes into the presence range or goes out of the away range of the Bluetooth proximity host 110. In this regard, the Bluetooth host controller 116a may be configured to keep monitoring and/or measuring received signal strength on the associated Bluetooth proximity device. In instances where the RSSI measurements for the associated Bluetooth proximity device such as the Bluetooth proximity device 120a at the position 1 becomes greater than a presence threshold value corresponding to the Bluetooth proximity presence range, the Bluetooth host controller 116a may automatically generate a Bluetooth proximity presence trigger. The Bluetooth host controller 116a may send the generated Bluetooth proximity presence trigger in a HCI event to the Bluetooth host device 112 indicating the presence of the Bluetooth proximity device 120a within the presence range. In instances where the RSSI measurements for the Bluetooth proximity device such as the Bluetooth proximity device 120a at the position 1 becomes less than an away threshold value corresponding to a Bluetooth proximity away range, the Bluetooth host controller 116a may automatically generate a Bluetooth proximity away trigger. The Bluetooth host controller 116a may send the generated Bluetooth proximity away trigger in a HCI event to the Bluetooth host device 112 indicating the presence of the Bluetooth proximity device 130a within the away range.

In an exemplary embodiment of the invention, the Bluetooth host controller 116a may be configured to keep the Bluetooth host controller device 116 powered up while the Bluetooth host device 112 transitioning between a normal power mode and a low power mode. In this regard, the Bluetooth host controller 116a may be operable to manage the Bluetooth baseband 116b and the Bluetooth RF 116c for RSSI measurements on the associated Bluetooth proximity device even in instances when the Bluetooth host device 112 stays in a low power mode.

The Bluetooth baseband 116b may comprise suitable logic, circuitry, interfaces and/or code that are operable to provide Bluetooth baseband functionality to support Bluetooth applications.

The Bluetooth RF 116c may comprise suitable logic, circuitry, interfaces and/or code that are operable to convert Bluetooth signals between RF bands and Bluetooth basebands to support Bluetooth applications.

The memory 118 may comprise suitable logic, circuitry, interfaces and/or code that may be operable to store information such as executable instructions and data that may be utilized by the Bluetooth host device 112. The memory 118 may comprise RAM, ROM, low latency nonvolatile memory such as flash memory and/or other suitable electronic data storage.

Although a presence range and an away range are illustrated in FIG. 1 for reducing power consumption in Bluetooth proximity implementations via configuring the Bluetooth host controller for implementing corresponding triggers, the invention may not be so limited. Accordingly, three or more ranges for reducing power consumption in Bluetooth proximity implementations via configuring the Bluetooth host controller for implementing corresponding triggers may be supported without departing from the spirit and scope of various embodiments of the invention.

In an exemplary operation, the Bluetooth proximity host 110 may be operable to estimate distance from an associated Bluetooth device based on signal strength of a corresponding Bluetooth connection. The Bluetooth proximity host 110 may perform various actions such as auto logon or auto logoff, and run applications for the associated Bluetooth proximity device such as the Bluetooth proximity device 120a at the position 1. In this regard, the Bluetooth host device 112 may be operable to send a HCI command providing instructions to the Bluetooth host controller 116a for implementing a Bluetooth proximity presence trigger and a Bluetooth proximity away trigger at a time when a Bluetooth proximity device enters into the presence range or goes out of the away range of the Bluetooth proximity host 110. The Bluetooth host controller 116a may be operable to track relative distances to Bluetooth proximity devices by monitoring and/or measuring received signal strength on corresponding Bluetooth proximity devices. Without being requested by the Bluetooth host device 112, the Bluetooth host controller 116a may automatically generate a Bluetooth proximity presence trigger at a time when RSSI measurements for the associated Bluetooth proximity device such as the Bluetooth proximity device 120a at the position 1 becomes greater than a presence threshold value corresponding to the presence range. The Bluetooth host controller 116a may be operable to send the generated Bluetooth proximity presence trigger utilizing a HCI event to the Bluetooth host device 112. Upon receiving the Bluetooth proximity presence trigger from the Bluetooth host controller 116a, the Bluetooth host device 112 may start performing actions or running applications related to the presence condition of the Bluetooth proximity device 120a. In instances where RSSI measurements for the associated Bluetooth proximity device such as the Bluetooth proximity device 120a at the position 2 becomes less than an away threshold value corresponding to the Bluetooth proximity away range, a Bluetooth proximity away trigger may be automatically generated by the Bluetooth host controller 116a, without being requested by the Bluetooth host device 112, for the Bluetooth proximity device 130a. The generated Bluetooth proximity away trigger may be sent to the Bluetooth host device 112 utilizing a HCI event. Upon receiving the Bluetooth proximity away trigger from the Bluetooth host controller 116a, the Bluetooth host device 112 may perform actions or run applications related to the away condition of the Bluetooth host device 112. For example, the Bluetooth host device 112 may suspend, start, or stop running certain applications. In this regard, the Bluetooth host device 112 may enter into a low power mode to reduce power consumption on the Bluetooth host device 112. The Bluetooth host controller device 116 may be configured to stay powered up for proximity measurements during the transitioning of the Bluetooth host device 112 between a normal power mode and a low power mode. Existing functionality on the Bluetooth proximity host 110 and corresponding Bluetooth proximity devices may be maintained or protected without being interrupted due to the proximity measurements.

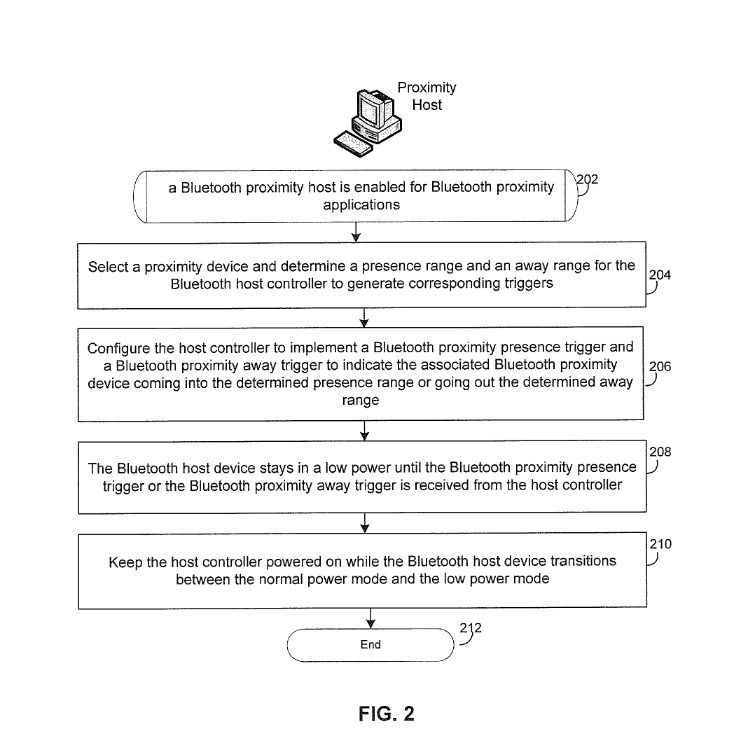

FIG. 2 is a block diagram illustrating exemplary steps that may be performed by a Bluetooth proximity host to reduce power consumption of the Bluetooth host device while keeping the Bluetooth host controller powered up, in accordance with an embodiment of the invention. Referring to FIG. 2, the exemplary steps may start with step 202. In step 202, the Bluetooth proximity host 110 is enabled for Bluetooth proximity applications for an associated Bluetooth proximity device. In step 204, the Bluetooth proximity host 110 may be operable to select a proximity device and determine a presence range and an away range for the Bluetooth host controller 116a to generate corresponding triggers. In step 206, the Bluetooth proximity host device 110 may be operable to configure the Bluetooth host controller 116a to send a Bluetooth proximity presence trigger and/or a Bluetooth proximity away trigger to indicate the presence of an associated Bluetooth proximity device within the determined presence range and the presence of the associated Bluetooth proximity device outside of the determined away range, respectively. In step 208, the Bluetooth proximity 110 may manage or control the Bluetooth host device 112 to stay in a low power mode until the Bluetooth proximity presence trigger or the Bluetooth proximity away trigger is received from the host controller 116a. In step 210, the Bluetooth proximity host 110 may be configured to keep the Bluetooth host controller 116a powered on while the Bluetooth host device 112 transitions between a normal power mode and the low power mode. The exemplary steps stop in step 212.

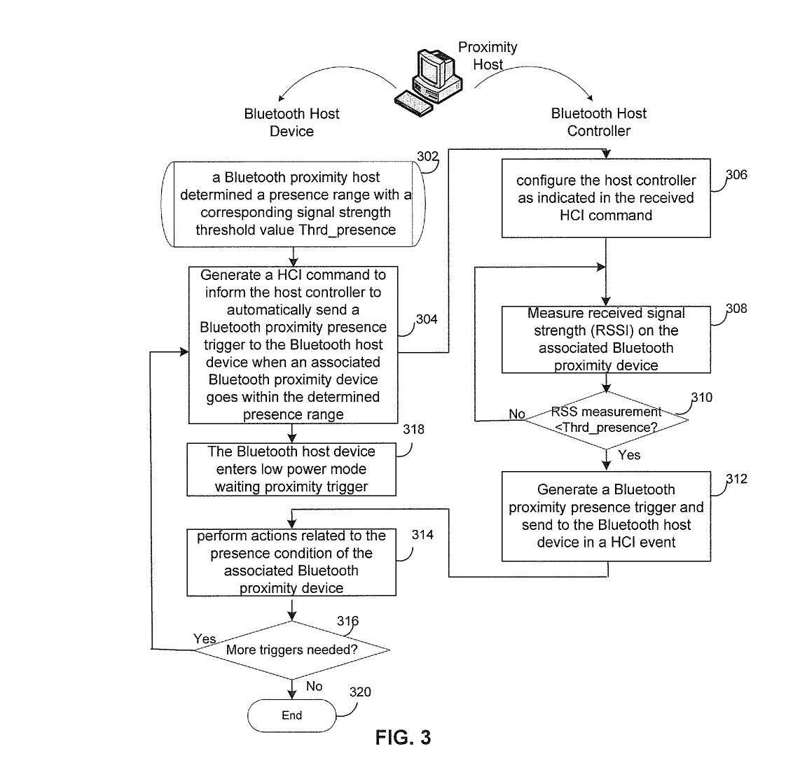

FIG. 3 is a block diagram illustrating exemplary steps that may be performed by a Bluetooth proximity host to configure the Bluetooth host controller to notify the Bluetooth host device if an associated Bluetooth proximity device comes into the proximity of the Bluetooth proximity host, in accordance with an embodiment of the invention. Referring to FIG. 3, the exemplary steps start with step 302. In step 302, a presence range with a corresponding signal strength threshold value, denoted as Thrd_presence, is determined for the Bluetooth proximity host 110. In step 304, the Bluetooth proximity host 110 may be operable to generate a HCI command in the Bluetooth host device 112 to inform the Bluetooth host controller 116a to configure itself to automatically send a Bluetooth proximity presence trigger to the Bluetooth host device 112 only if a Bluetooth proximity device such as the Bluetooth proximity device 120a at the position 1 is within the determined presence range. After the Bluetooth proximity host device 112 has configured the Bluetooth host controller 116b to notify about the presence of the proximity device 120a, the Bluetooth proximity host device 112 may enter a low power mode in step 318 and wait for the proximity event to occur. In step 306, the Bluetooth host controller 116a may configure itself based on the instructions in the received HCI command.

In step 308, the Bluetooth host controller 116a may manage or control the Bluetooth baseband 116b and the Bluetooth RF 116c to measure received signal strength (RSSI) of the Bluetooth proximity device. RSSI measurements or RSSI measurements plus transmit power level of the Bluetooth proximity device may indicate or measure distance between the Bluetooth proximity host device 112 and the Bluetooth proximity device. In instance where the RSSI measurements are utilized to measure the distance between the Bluetooth proximity host device 112 and the Bluetooth proximity device, then in step 310, it may be determined whether the RSSI measurements for the Bluetooth proximity device become greater than the threshold value Thrd_presence. In instances where the RSSI measurements for the associated Bluetooth proximity device become greater than the threshold value Thrd_presence, then in step 312. In step 312, the Bluetooth host controller 116a may generate a Bluetooth proximity presence trigger and send the generated Bluetooth proximity presence trigger utilizing a HCI event to the Bluetooth host device 112. In step 314, the Bluetooth proximity host 110 may ensure that the Bluetooth host device 112 powered up so as to perform desired actions, for example, auto login and/or other similar applications, related to the presence of the associated Bluetooth proximity device. In step 316, it may be determined whether the Bluetooth proximity host 110 needs to configure one or more additional proximity triggers. In instances where additional proximity triggers are needed, the exemplary steps return to step 304.

In step 310, in instances where the RSSI measurements for the associated Bluetooth proximity device becomes less than the threshold value Thrd_presence, then the exemplary steps return to step 308.

In step 316, in instances where the Bluetooth host device 112 does not need to set additional proximity triggers, then the exemplary steps may end in 320.

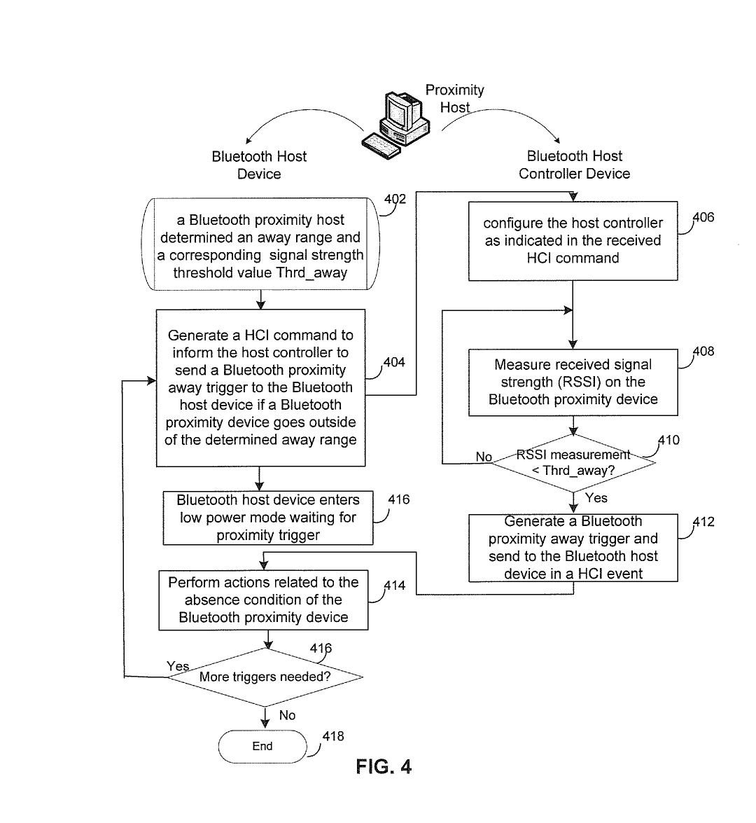

FIG. 4 is a block diagram illustrating exemplary steps that may be performed by a Bluetooth proximity host to configure the Bluetooth host controller to notify the Bluetooth host device if an associated Bluetooth proximity device gets out of the proximity range of the Bluetooth proximity host, in accordance with an embodiment of the invention. Referring to FIG. 4, the exemplary steps start with step 402. In step 402, an away range with a corresponding signal strength threshold value, denoted as Thrd_away, is determined for the Bluetooth proximity host 110. In step 404, the Bluetooth proximity host 110 may be operable to generate a HCI command in the Bluetooth host device 112 to inform the Bluetooth host controller 116a to configure itself to automatically send a Bluetooth proximity away trigger to the Bluetooth host device 112 if the associated Bluetooth proximity device such as the Bluetooth proximity device 120a at the position 2 goes outside of the determined away range. After the Bluetooth proximity host device 112 has configured the Bluetooth host controller 116b to notify about the absence of the proximity device 120a, the Bluetooth proximity host device 112 may enter a low power mode in step 416 and wait for the proximity event to occur. In step 406, the Bluetooth host controller 116a may configure itself based on the instructions in the received HCI command. In step 408, the Bluetooth host controller 116a may manage the Bluetooth baseband 116b and the Bluetooth RF 116c to measure received signal strength (RSSI) of the associated Bluetooth proximity device. In step 410, it may be determined whether the RSSI measurements for the associated Bluetooth proximity device becomes less than the threshold value Thrd_away. In instances where the RSSI measurements for the Bluetooth proximity device becomes less than the threshold value Thrd_away, then in step 412. In step 412, the Bluetooth host controller 116a may generate a Bluetooth proximity away trigger and send the generated Bluetooth proximity away trigger in a HCI event to the Bluetooth host device 112. In step 414, the Bluetooth proximity host 110 may perform actions or running applications, on the Bluetooth host device 112, related to the absence condition of the associated Bluetooth proximity device. For example, the Bluetooth host device 112 may stop running applications to monitor the relative distance to the associated Bluetooth proximity device on the Bluetooth host device 112. In step 416, the Bluetooth host device 112 may determine if new triggers need to be set. In instances where one or more new triggers are needed, the exemplary steps return to step 404. The exemplary steps may end in step 418.

In step 410, in instances where the RSSI measurements for the associated Bluetooth proximity device become greater than the threshold value Thrd_away, then the exemplary steps return to step 408.

In various exemplary aspects of the method and system for reducing power consumption in Bluetooth proximity implementations, a Bluetooth proximity host communication device such as the Bluetooth proximity host 110 may comprise the Bluetooth host device 112 and the Bluetooth host controller 116a in the Bluetooth host controller device 116. The Bluetooth host device 112 may be operable to transmit a HCI command comprising instructions to configure the Bluetooth host controller 116a. The Bluetooth host device 112 may inform the Bluetooth host controller 116a to implement a Bluetooth proximity presence trigger and a Bluetooth proximity away trigger, which may be utilized to indicate an associated Bluetooth proximity device coming into a presence range and going outside of an away range of the Bluetooth proximity host 110, respectively. The Bluetooth proximity host 110 may be operable to manage the Bluetooth host device 112 to perform actions related to presence or absence condition of the Bluetooth host controller 116a.

The Bluetooth host controller 116a may be operable to manage or control the Bluetooth baseband 116b and the Bluetooth RF 116c to measure received signal strength of the associated Bluetooth proximity device. The Bluetooth host controller 116a may compare the RSSI measurements with a presence threshold value corresponding to the presence range of the Bluetooth proximity host 110. In instances where the RSSI measurements for the associated Bluetooth proximity device becomes greater than the presence threshold value, the Bluetooth host controller 116a may be operable to generate the Bluetooth proximity presence trigger indicating the presence of the associated Bluetooth proximity device within the presence range. The Bluetooth host controller 116a may be operable to transmit the generated Bluetooth proximity presence trigger in a HCI event to the Bluetooth host device 112.

The Bluetooth host device 112 may be triggered to start running applications such as auto logon related to the presence of the Bluetooth proximity device. In instances where the RSSI measurements for the Bluetooth proximity device becomes less than an away threshold value corresponding to an away range of the Bluetooth proximity host 110, the Bluetooth host controller 116a may automatically generate a Bluetooth proximity away trigger. The Bluetooth host controller 116a may transmit the generated Bluetooth proximity away trigger in a HCI event to the Bluetooth host device 112. The Bluetooth host device 112 may be triggered to perform actions such as logoff or suspend. In this regard, the Bluetooth host device 112 may stay in the low power mode until one of the Bluetooth proximity presence trigger and the Bluetooth proximity away trigger is received from the Bluetooth host controller 116a.

In various exemplary aspects of the method and system for reducing power consumption in Bluetooth proximity implementations, a Bluetooth host controller such as the Bluetooth host controller 116a, in the Bluetooth host controller device 116 that is located in the Bluetooth proximity host 110 comprising the Bluetooth host device 112, is operable to automatically generate the Bluetooth proximity presence trigger in instances when an associated Bluetooth proximity device such as the Bluetooth proximity device 120a at the position 1 enters the presence range of the Bluetooth proximity host 110. The Bluetooth host controller 116a is operable to generate the Bluetooth proximity away trigger in instances when the associated Bluetooth proximity device such as the Bluetooth proximity device 120a at the position 2 goes out of the away range of the Bluetooth proximity host 110. One of the Bluetooth proximity presence trigger and the Bluetooth proximity away trigger may be communicated to the Bluetooth host device 112 to control specific applications run or performed on the Bluetooth host device 112.

The Bluetooth host controller 116a may be operable to manage or control the Bluetooth baseband 116b and the Bluetooth RF 116c to measure received signal strength of signals communicated by the associated Bluetooth proximity device. The Bluetooth host controller 116a may compare the RSSI measurements with the presence threshold value of the Bluetooth proximity host 110. In instances where the RSSI measurements for the associated Bluetooth proximity device becomes greater than the presence threshold value, the Bluetooth host controller 116a may be operable to automatically generate the Bluetooth proximity presence trigger indicating the presence of the associated Bluetooth proximity device within the presence range. The Bluetooth host controller 116a may be operable to transmit the generated Bluetooth proximity presence trigger in a HCI event to the Bluetooth host device 112.

The Bluetooth host device 112 may be triggered to control or start execution of one or more applications such as auto logon related to the presence condition of the associated Bluetooth proximity device. In instances where the RSSI measurements for the associated Bluetooth proximity device becomes less than the away threshold value, the Bluetooth host controller 116a may automatically generate a Bluetooth proximity away trigger. The Bluetooth host controller 116a may transmit the generated Bluetooth proximity away trigger in a HCI event to the Bluetooth host device 112. The Bluetooth host device 112 may be triggered to control or run applications related to the absence condition of the Bluetooth proximity device. For example, the Bluetooth host device 112 may start or stop execution of one or more applications, logoff, or enter a sleep state. In this regard, the Bluetooth host device 112 may stay in the low power mode until one of the Bluetooth proximity presence trigger and the Bluetooth proximity away trigger is received from the Bluetooth host controller 116a.

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for reducing power consumption in Bluetooth proximity implementations.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for communication, the method comprising:
performing by a Bluetooth host controller that is located within a Bluetooth proximity host communication device:
generating a Bluetooth presence trigger when a Bluetooth proximity device enters a corresponding presence range of said Bluetooth proximity host communication device; and
generating a Bluetooth away trigger when a Bluetooth proximity device goes out of a corresponding away range of said Bluetooth proximity host communication device, wherein actions performed on said Bluetooth proximity host communication device are controlled based on said one of said Bluetooth presence trigger and said Bluetooth away trigger.

2. The method according to claim 1, comprising measuring received signal strength (RSSI) of signals communicated by said Bluetooth proximity device.

3. The method according to claim 2, comprising comparing said RSSI measurements with a presence threshold value corresponding to said presence range and/or an away threshold value corresponding to said away range of said Bluetooth proximity host communication device for said controlling of said actions performed by a Bluetooth host device that is located in said Bluetooth proximity host communication device.

4. The method according to claim 3, comprising if said RSSI measurements are greater than said presence threshold value, generating by said Bluetooth host controller, said Bluetooth presence trigger.

5. The method according to claim 4, comprising transmitting, by said Bluetooth host controller, an event comprising said generated Bluetooth presence trigger, to said Bluetooth host device.

6. The method according to claim 5, wherein said Bluetooth host device starts or stops execution of one or more applications related to presence condition of said Bluetooth proximity device based on said received event.

7. The method according to claim 3, comprising if said RSSI measurements are less than said away threshold value, generating, by said Bluetooth host controller, said Bluetooth away trigger.

8. The method according to claim 7, comprising transmitting, by said Bluetooth host controller, an event comprising said generated Bluetooth away trigger, to said Bluetooth host device.

9. The method according to claim 8, wherein said Bluetooth host device controls execution of one or more applications related to away condition of said Bluetooth proximity device based on said received event.

10. The method according to claim 1, wherein said Bluetooth host device stays in a low power mode until one of said generated Bluetooth presence trigger or said generated Bluetooth away trigger is received from said Bluetooth host controller.

11. A system for communication, the system comprising:
one or more processors and/or circuits for use in a Bluetooth host controller that is located within a Bluetooth proximity host communication device, said one or more processors and/or circuits being operable to:
generate a Bluetooth presence trigger when a Bluetooth proximity device enters a corresponding presence range of said Bluetooth proximity host communication device; and
generate a Bluetooth away trigger when a Bluetooth proximity device goes out of a corresponding away range of said Bluetooth proximity host communication device, wherein actions performed on said Bluetooth proximity host communication device are controlled based on said one of said Bluetooth presence trigger and said Bluetooth away trigger.

12. The system according to claim 11, wherein said one or more processors and/or circuits being operable to measure received signal strength (RSSI) of signals communicated by said Bluetooth proximity device.

13. The system according to claim 12, wherein said one or more processors and/or circuits being operable to compare said RSSI measurements with a presence threshold value corresponding to said presence range and/or an away threshold value corresponding to said away range of said Bluetooth proximity host communication device for said controlling of said actions performed by a Bluetooth host device that is located in said Bluetooth proximity host communication device.

14. The system according to claim 13, wherein said one or more processors and/or circuits being operable to generate, by said Bluetooth host controller, said Bluetooth presence trigger, if said RSSI measurements are greater than said presence value.

15. The system according to claim 14, wherein said one or more processors and/or circuits being operable to transmit, by said Bluetooth host controller, an event comprising said Bluetooth presence trigger, to said Bluetooth host device.

16. The system according to claim 15, wherein said Bluetooth host device starts or stops execution of one or more applications related to presence condition of said Bluetooth proximity device based on said received event.

17. The system according to claim 13, wherein said one or more processors and/or circuits being operable to generate, by said Bluetooth host controller, said Bluetooth away trigger, if said RSSI measurements are less than said threshold value.

18. The system according to claim 17, wherein said one or more processors and/or circuits being operable to transmit, by said Bluetooth host controller, an event comprising said Bluetooth away trigger, to said Bluetooth host device.

19. The system according to claim 18, wherein said Bluetooth host device controls execution of one or more applications related to away condition of said Bluetooth proximity device based on said received event.

20. The system according to claim 11, wherein said Bluetooth host device stays in a low power mode until one of said generated Bluetooth presence trigger or said generated Bluetooth away trigger is received from said Bluetooth host controller.
